(19) United States
(12) Patent Application Publication
(10) Pub. No.: US 2008/0151040 A1
(43) Pub. Date: Jun. 26, 2008

(54) THREE-DIMENSIONAL IMAGE DISPLAY APPARATUS AND METHOD AND SYSTEM FOR PROCESSING THREE-DIMENSIONAL IMAGE SIGNAL

(75) Inventor: Ik-song KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/751,647

(22) Filed: May 22, 2007

(30) Foreign Application Priority Data
Dec. 26, 2006 (KR) 10-2006-0133888

(51) Int. Cl. H04N 15/00

(52) U.S. Cl. 348/42; 348/E15.001

(57) ABSTRACT

A three-dimensional (3D) image display apparatus, a method and a system which process a 3D image signal are provided. The 3D image display apparatus includes an input unit which receives an input of a left-eye image frame and a right-eye image frame with a specified time difference between the frames, a 3D image frame generation unit which generates a 3D image frame by extracting part of pixels from the left-eye image frame and extracting part of pixels from the right-eye image frame, and a projection unit which divides the 3D image frame into a left-eye image sub-frame and a right-eye image sub-frame and successively projects the divided sub-frames on a screen. Accordingly, the 3D image signal is divided into the left-eye image frame and the right-eye image frame, and thus the scaling of the image signal and the improvement of the image quality allow a clearer image to be presented.

### CROSS-REFERENCE TO RELATED APPLICATIONS

This application claims priority from Korean Patent Application No. 2006-133888, filed on Dec. 26, 2006, in the Korean Intellectual Property Office, the entire disclosure of which is incorporated herein by reference.

### BACKGROUND OF THE INVENTION

1. Field of the Invention

Apparatuses and methods consistent with the present invention relate to processing a three-dimensional (3D) image signal, and more particularly processing a 3D image signal, which can represent a clear 3D image by making it possible to perform a scaling of the 3D image signal, a control of image sharpness, and so forth.

2. Description of the Related Art

Generally, a 3D image is generated by making a user's left and right eyes recognize different images and synthesizing the recognized left and right images in the user's mind.

One display device that can represent 3D images is a projection television receiver (TV). Diverse kinds of image display elements are used in the projection TV, and a projection TV that uses a digital micromirror device (DMD) has been commercialized.

The DMD is a semiconductor optical switch integrated with a micromirror. The DMD includes an aluminum alloy micromirror which is mounted on a static random access memory (SRAM) and controls the reflection of light from the micromirror as it moves in the range of ±12° in accordance with an on/off state of the optical switch.

FIG. 1 is a block diagram illustrating the construction of a related art projection TV that processes a 3D image.

A projection TV 10 processes a digital image signal and an analog image signal provided wirelessly, and a digital image signal provided through a High-Definition Multimedia Interface (HDMI) terminal, and displays the processed image signal on a display screen in order to simplify the description, in the exemplary embodiments of the present invention, it is assumed that a projection TV processes a digital image signal provided wirelessly.

The projection TV 10 comprises a digital tuner 2, a decoder 3, a scaler 4, a video enhancer 5, and a projection unit 6.

The digital tuner 2 selectively receives a digital image signal that corresponds to a channel selected by a user, and the decoder 3 decodes the digital image signal.

The scaler 4 converts the resolution of the decoded image signal into the resolution set in the display device.

The video enhancer 5 controls the image sharpness by peaking the digital image signal by bands. For example, the video enhancer 5 heightens the sharpness of the image signal by greatly enhancing the signal level of a high-frequency component of the image signal.

The projection unit 6 comprises a Digital Micromirror Device (DMD) 7 and a DMD driving unit 8 for driving the DMD 7.

To provide each frame of a 3D image signal to the projection TV 10, a left-eye image signal that is input to the left eye and a right-eye image signal that is input to the right eye are interleaved in the unit of a pixel. The right-eye image signal and the left-eye image signal are formed with a specified time difference between them, and thus if the scaler 4 converts the resolution or the video enhancer 5 performs the peaking, the 3D image signal is deformed and thus cannot be represented.

Accordingly, a two-dimensional (2D) image signal is processed through the scaler 4 and the video enhancer 5, but a 3D image signal bypasses the scaler 4 and the video enhancer 5 and goes to the projection unit 6. The DMD driving unit 8 of the projection unit 6 drives the DMD 7 to project the right-eye image signal and the left-eye image signal with the time difference between them.

As described above, according to the related art projection TV 10, since the circuit elements such as the scaler 4 and the video enhancer 5 cannot be used during processing the 3D image signal, the 3D image signal input from a signal source is directly projected on the screen with its resolution fixed, and thus the image quality cannot be controlled.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide a 3D image display apparatus, a method and a system for processing a 3D image signal, which can represent a clear 3D image by making it possible to perform a scaling of the 3D image signal in digital and analog forms input from various signal sources, control of image sharpness, and so forth.

According to an aspect of the present invention, there is provided a 3D image display apparatus, which comprises an input unit for receiving an input of a left-eye image frame and a right-eye image frame with a specified time difference between the frames; a 3D image frame generation unit for generating a 3D image frame by extracting part of the pixels from the left-eye image frame and extracting part of the pixels from the right-eye image frame; and a projection unit for dividing the 3D image frame into a left-eye image sub-frame and a right-eye image sub-frame and successively projecting the divided sub-frames on a screen.

The 3D image display apparatus may further comprise a scaler for controlling resolutions of the left-eye image frame and the right-eye image frame.

The 3D image frame generation unit may generate the 3D image frame by alternately selecting the pixels that belong to the left-eye image frame and the pixels that belong to the right-eye image frame.

A pair of the left-eye image sub-frame and the right-eye image sub-frame may be projected on the screen for a time when one frame is projected.

The 3D image frame generation unit may generate the 3D image frame by selecting odd-numbered pixels of odd-numbered pixel lines of the left-eye image frame and even-numbered pixels of even-numbered pixel lines of the left-eye image frame, and by selecting even-numbered pixels of odd-numbered pixel lines of the right-eye image frame and odd-numbered pixels of even-numbered pixel lines of the right-eye image frame.

The 3D image frame generation unit may generate the 3D image frame by selecting odd-numbered pixels of odd-numbered pixel lines of the right-eye image frame and even-numbered pixels of even-numbered pixel lines of the right-eye image frame, and by selecting even-numbered pixels of odd-numbered pixel lines of the left-eye image frame and odd-numbered pixels of even-numbered pixel lines of the left-eye image frame.

The 3D image frame generation unit may select the pixels by judging whether the pixels are the pixels of the right-eye image frame or the pixels of the left-eye image frame through analysis of a histogram representing a level distribution of the image signal.

The projection unit may comprise a DMD for reflecting light onto the screen; and a DMD driving unit for controlling an operation of the DMD so that the 3D image frame is divided into the right-eye image sub-frame and the left-eye image sub-frame and the divided sub-frames are projected.

The 3D image display apparatus according to exemplary embodiments of the present invention may further comprise a 3D-glasses control unit for controlling an operation of 3D glasses having left-eye glasses and right-eye glasses that are selectively turned on.

The 3D-glasses control unit may control the turn-on order of the left-eye glasses and the right-eye glasses in accordance with the projection order of the left-eye image sub-frame and the right-eye image sub-frame.

The 3D-glasses control unit may preferentially turn on the left-eye glasses in the case where the left-eye image sub-frame is preferentially projected, and may preferentially turn on the right-eye glasses in the case where the right-eye image sub-frame is preferentially projected.

The input unit may be one of a digital tuner for receiving a digital image signal, an analog tuner for receiving an analog image signal, and a HDMI processing unit for receiving an input of a signal from an external device.

According to another aspect of the present invention, there is provided a 3D image system, which comprises a 3D image display apparatus comprising an input unit for receiving an input of a left-eye image frame and a right-eye image frame with a specified time difference between the frames, a 3D image frame generation unit for generating a 3D image frame by extracting part of pixels from the left-eye image frame and extracting part of pixels from the right-eye image frame, and a projection unit for dividing the 3D image frame into a left-eye image sub-frame and a right-eye image sub-frame and successively projecting the divided sub-frames on a screen; and 3D glasses having left-eye glasses and right-eye glasses operating in accord with the projection order of the left-eye image sub-frame and the right-eye image sub-frame.

According to still another aspect of the present invention, there is provided a method of processing a 3D image for a 3D image display apparatus, which comprises receiving an input of a left-eye image frame and a right-eye image frame with a specified time difference between the frames; generating a 3D image frame by extracting part of pixels from the left-eye image frame and extracting part of pixels from the right-eye image frame; and dividing the 3D image frame into a left-eye image sub-frame and a right-eye image sub-frame and successively projecting the divided sub-frames on a screen.

### BRIEF DESCRIPTION OF THE DRAWINGS

The above and other aspects of the present invention will become more apparent and readily appreciated from the following description of the exemplary embodiments, taken in conjunction with the accompany drawings of which:

FIG. 1 is a block diagram illustrating the construction of a related art projection TV that processes a 3D image;

FIG. 2 is a view explaining the input order of a 3D image signal in the unit of a frame;

FIG. 3 is a block diagram illustrating the construction of a 3D image display apparatus capable of displaying a 3D image according to an exemplary embodiment of the present invention;

FIG. 4A is a view illustrating a left-eye image frame and a right-eye image frame that are successively input;

FIG. 4B is a view illustrating the construction of a 3D image frame;

FIG. 4C is a view illustrating pixels of a left-eye image sub-frame and a right-eye image sub-frame arranged by DMD;

FIG. 4D is a view illustrating a 3D image frame, which is recognized through the projection of a left-eye image sub-frame and a right-eye image sub-frame, arranged by DMD;

FIG. 5 is a graph illustrating a histogram of a 3D image signal;

FIG. 6A is a view illustrating a right-eye image frame and a left-eye image frame that are successively input;

FIG. 6B is a view illustrating the construction of a 3D image frame generated when a right-eye image frame and a left-eye image frame of FIG. 6A are successively input;

FIG. 7 is a view illustrating a 3D image that is projected on a screen and seen without wearing of 3D glasses; and

FIG. 8 is a flowchart illustrating a digital image signal process performed by the 3D image display apparatus according to an exemplary embodiment of the present invention.

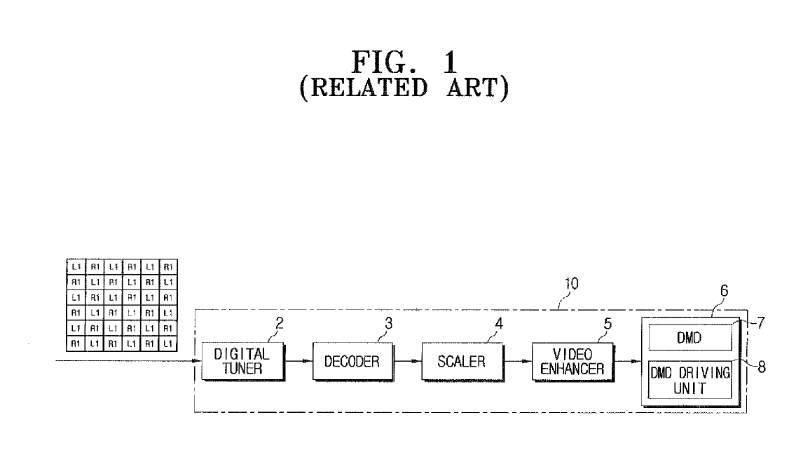

Throughout the drawings, like reference numerals will be understood to refer to like parts, components and structures.

### DETAILED DESCRIPTION OF EXEMPLARY EMBODIMENTS

Exemplary embodiments of the present invention will now be described in detail with reference to the annexed drawings. In the drawings, the same elements are denoted by the same reference numerals throughout the drawings. In the following description, detailed descriptions of known functions and configurations incorporated herein have been omitted for conciseness and clarity.

A 3D image processing system according to an exemplary embodiment of the present invention comprises a projection TV having a DMD and liquid crystal shutter type glasses. The projection TV that is used as the 3D image display apparatus according to the exemplary embodiment of the present invention generates a 3D image by processing a 3D image signal irrespective of the types of the image signal, i.e., irrespective of whether the 3D image signal is a digital image signal or an analog image signal provided wirelessly, or a digital image signal provided through an external device.

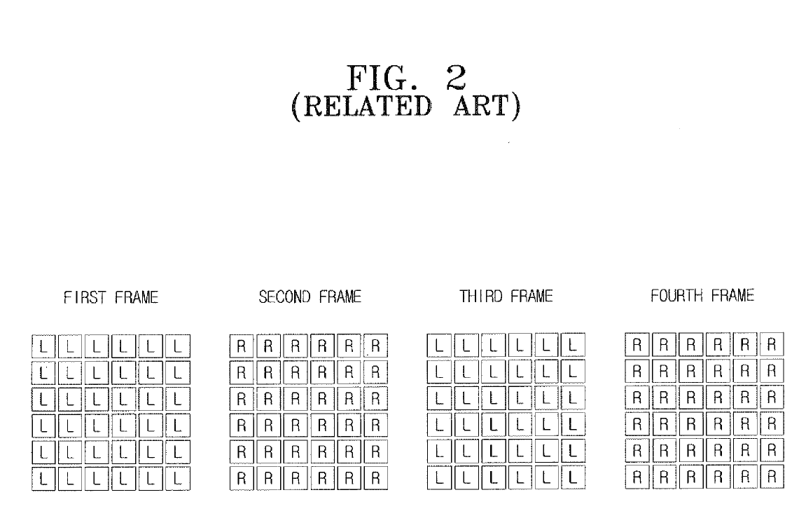

FIG. 2 is a view explaining the input order of a 3D image signal in the unit of a frame.

Referring to FIG. 2, the 3D image signal is composed of a left-eye image frame and a right-eye image frame that are alternately arranged. The left-eye image frame may be first input and the right-eye image frame may follow. Also, the right-eye image frame may be first input and the left-eye image frame may follow.

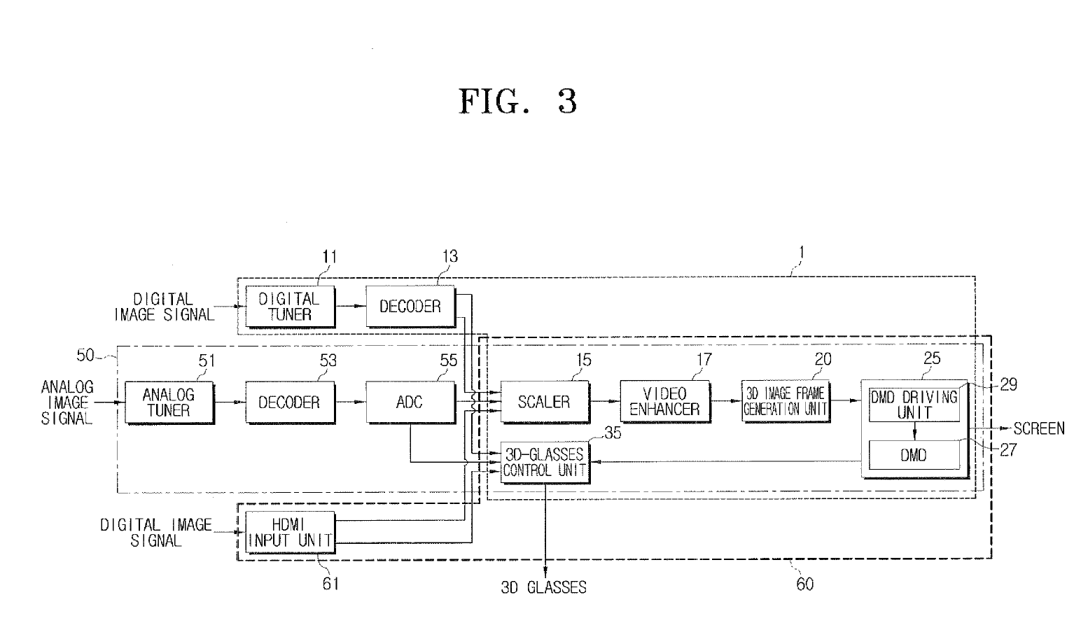

FIG. 3 is a block diagram illustrating the construction of a 3D image display apparatus capable of displaying a 3D image according to an exemplary embodiment of the present invention.

The 3D image display apparatus according to an exemplary embodiment of the present invention comprises a digital image signal processing block 1, a analog image signal processing block 50, and an HDMI digital image signal processing block 60, and processes various types of 3D image signals.

In order to process the 3D image signal input in the form of the digital image signal acquired wirelessly, the digital image signal processing block 1 comprises a digital tuner 11, a decoder 13, a scaler 15, a 3D image frame generation unit 20, a video enhancer 17, a projection unit 25, and a 3D-glasses control unit 35. The scaler 15, the 3D image frame generation unit 20, the projection unit 25, and the 3D-glasses control unit 35 are commonly used by the digital image signal processing block 1, the analog image signal processing block 50, and the HDMI digital image signal processing block 60.

The digital tuner 11 selects only a digital image signal corresponding to a channel selected by a user among received digital image signals, amplifies the selected digital image signal, and converts the amplified digital image signal into an intermediate frequency band signal.

The decoder 13 decodes the 3D image signal, and converts the decoded 3D image signal into an image format.

The scaler 15 is composed of a horizontal scaler and a vertical scaler, and performs horizontal and vertical scaling of an RGB signal or a YUV signal, which is the digital image signal, and an H/V signal. Accordingly, the respective frames constituting the 3D digital image signal are scaled according to the resolution of a display screen. In the exemplary embodiment of the present invention, a left-eye image frame and a right-eye image frame are respectively formed and received, and thus the left-eye image frame and the right-eye image frame are respectively scaled by the scaler 15.

The video enhancer 17 controls the image sharpness by performing a peaking of the left-eye image frame and the right-eye image frame by signal bands.

The 3D image frame generation unit 20 receives the left-eye image frame and the right-eye image frame scaled by the scaler 15, and generates the 3D image frame in which the left-eye image signal and the right-eye image signal are interleaved. As illustrated in FIG. 2, if the left-eye image frame and the right-eye image frame are alternately input, the 3D image frame generation unit 20 generates a 3D image frame in which the left-eye image signal and the right-eye image signal are interleaved in the unit of a pixel by using the input odd-numbered left-eye image frame and the input even-numbered right-eye image frame.

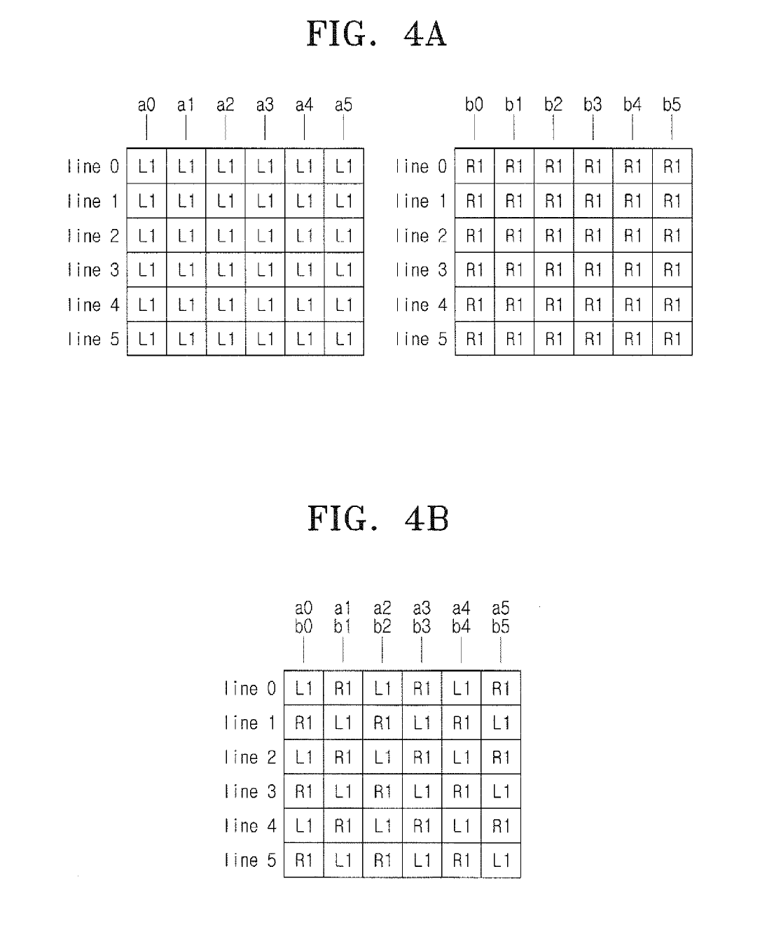

Specifically, the 3D image frame generation unit 20 selects the odd-numbered pixels in the first pixel line of the left-eye image frame and selects the even-numbered pixels in the second pixel line as shown in the left part of FIG. 4A. That is, in the odd-numbered pixel lines of the left-eye image frame, the odd-numbered pixels are selected, and in the even-numbered pixel lines, the even-numbered pixels are selected.

In addition, the 3D image frame generation unit 20 selects the even-numbered pixels in the odd-numbered pixel lines of the right-eye image frame and selects the odd-numbered pixels in the even-numbered pixel lines as shown in the right part of FIG. 4A. The pixels selected from the left-eye image frame and the right-eye image frame are alternately arranged.

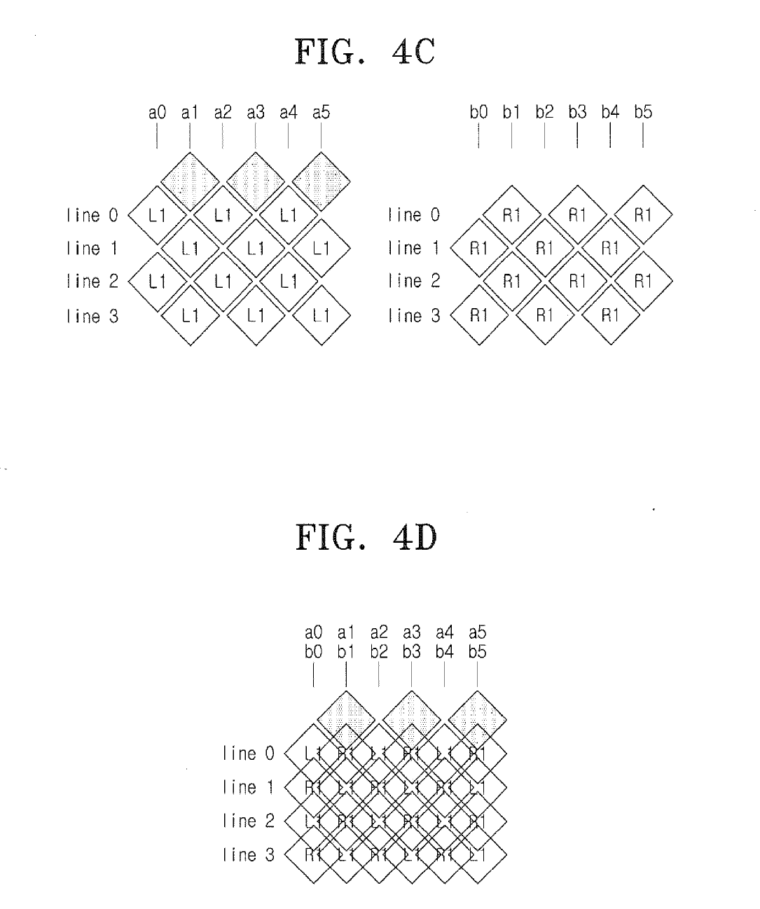

In order to successively select the pixels from the left-eye image frame and the right-eye image frame, the 3D image frame generation unit 20 should discriminate between the left-eye image frame and the right-eye image frame. For this, the 3D image frame generation unit 20 uses a histogram of an image signal as illustrated in FIG. 5. According to the histogram of the image signal, the left-eye image frame signal and the right-eye image frame signal have the same level, and the image signal of the right-eye image frame precedes the image signal of the left-eye image frame for a specified time. Accordingly, the 3D image frame generation unit 20 can determined whether the input frame is the right-eye image frame or the left-eye image frame by using the time difference between the right-eye image frame and the left-eye image frame.

When the pixels are selected as described above, the 3D image frame generation unit 20 generates one 3D image frame as illustrated in FIG. 4B by successively arranging the pixels selected from the left-eye image frame and the pixels selected from the right-eye image frame.

The projection unit 25 comprises a plurality of DMDs 27 and DMD driving units 29.

The DMD 27 has a micromirror which moves in the range of ±12° to adjust the reflection of light under the control of the DMD driving unit 29.

The DMD driving unit 29 drives the DMD 27 by a smooth picture driving method that is one of the DMD driving methods. The smooth picture driving method drives the DMD 27 to divide the 3D image frame into the left-eye image sub-frame and the right-eye image sub-frame as shown in FIG. 4C, and to successively project the divided sub-frames on the screen. In the left part of FIG. 4C, the left-eye image sub-frame is illustrated, and in the right part thereof, the right-eye image sub-frame is illustrated. The left-eye image sub-frame and the right-eye image sub-frame are composed of the pixels which are arranged to correspond to the position of the DMD 27.

If the left-eye image sub-frame and the right-eye image sub-frame are successively projected and displayed on the screen for a time when one frame is displayed, as shown in FIG. 4B, a user recognizes this as one 3D image frame in which the left-eye image sub-frame and the right-eye image sub-frame overlap each other.

In this case, the projection of 120 left-eye and right-eye image frames per second (i.e., at 120 Hz) corresponds to the projection of 30 3D-image frames per second (i.e., at 60 Hz). However, this does not mean that the resolution is reduced by ½. The 3D image frame is divided into the left-eye image sub-frame and the right-eye image sub-frame by the DMD 27, and the left-eye image sub-frame and the right-eye image sub-frame are alternately projected for a time when one frame is projected. That is, since the projection of two sub-frames, i.e., the left-eye image sub-frame and the right-eye image sub-frame, is the same as the projection of one frame, the resolution is not reduced.

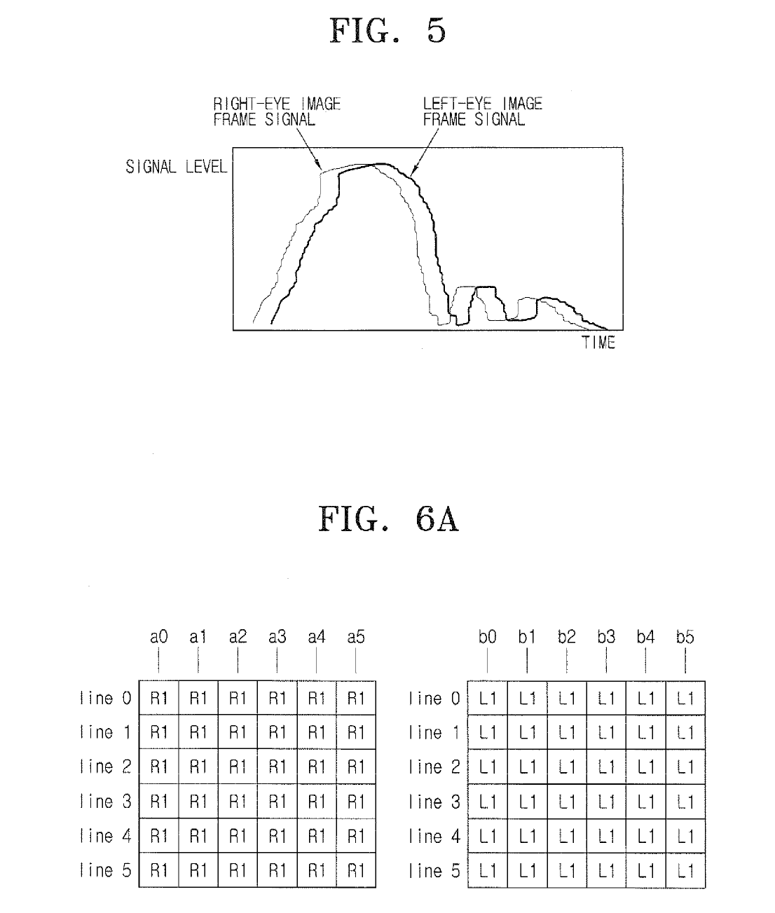

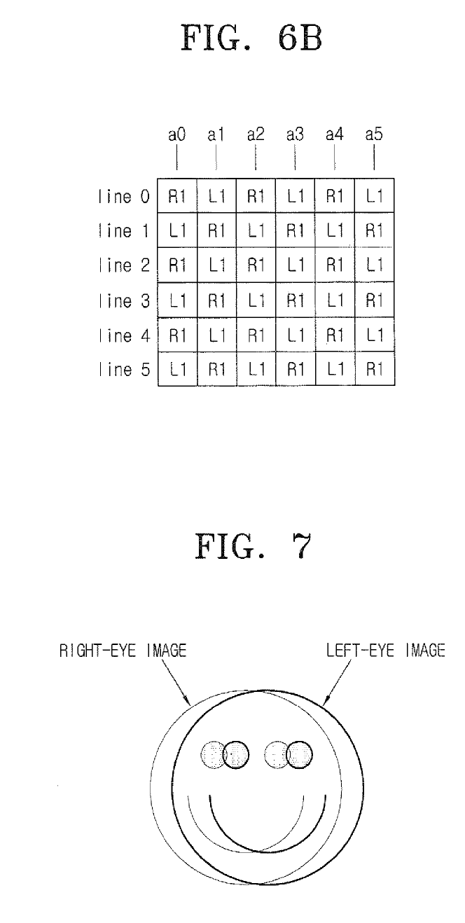

As shown in FIG. 2, the left-eye image frame may be first input and the right-eye image frame may follow. By contrast, as shown in FIG. 6A, the right-eye image frame may be first input, and the left-eye image frame may follow. In this case, the 3D image frame generation unit 20 selects the odd-numbered pixels in the odd-numbered pixel lines of the first input right-eye image frame, and selects the even-numbered pixels in the even-numbered pixel lines of the right-eye image frame. Also, the 3D image frame generation unit 20 selects the even-numbered pixels in the odd-numbered pixel lines of the left-eye image frame and selects the odd-numbered pixels in the even-numbered pixel lines of the left-eye image frame. Accordingly, as shown in FIG. 6B, the 3D image frame having a pixel order opposite to that of the 3D image frame as shown in FIG. 4B is formed.

The 3D-glasses control unit 35, under the control of the DMD driving unit 29, receives information on whether the sub-frame projected on the screen is the left-eye image sub-frame or the right-eye image sub-frame from the DMD 27, and controls the on/off order of the left-eye glasses and the right-eye glasses. For example, in the case of projecting the left-eye image sub-frame on the screen, the 3D-glasses control unit 35 first turns on the left-eye glasses. In this case, the left-eye glasses and the right-eye glasses are turned on for a time corresponding to 120 Hz, respectively.

The reason for controlling the turn-on order of the left-eye glasses and the right-eye glasses is that the left-eye image frame and the right-eye image frame form images in different positions. The left-eye image frame signal and the right-eye image frame signal have the time difference as described above, and if the left-eye glasses of the 3D glasses are first turned on when the right-eye image frame is input prior to the left-eye image frame as shown in FIG. 4D, the images input to the left eye and the right eye are reversed. In the same manner, if the right-eye glasses of the 3D glasses are first turned on when the left-eye image frame is input prior to the right-eye image frame as shown in FIG. 4D, the images input to the left eye and the right eye are reversed. Accordingly, in order to view the 3D image, the 3D-glasses control unit 35 should turn on the left-eye glasses when the left-eye image sub-frame is projected, and should turn on the right-eye glasses when the right-eye image sub-frame is projected.

On the other hand, the sky-wave analog image signal processing block 50 as illustrated in FIG. 3 comprises an analog tuner 51, an analog-to-digital converter (ADC) 55, a decoder 53, a scaler 15, a video enhancer 17, a 3D image frame generation unit 20, a projection unit 25, and a 3D-glasses control unit 35, and processes the 3D analog image signal. The scaler 15, the 3D image frame generation unit 20, the projection unit 25, and the 3D-glasses control unit 35 are commonly used by the digital image signal processing block 1, the analog image signal processing block 50, and the HDMI digital image signal processing block 60, the detailed explanation thereof will be omitted.

The analog tuner 51 selectively receives and processes an analog image signal of a channel selected by a user. The decoder 53 decodes the analog image signal, and the ADC 55 converts the analog image signal into a digital image signal. The left-eye image frame and the right-eye image frame, which constitute the converted digital image signal, are provided to the scaler 15.

The scaler 15 performs a scaling of the left-eye image frame and the right-eye image frame in accordance with the resolution of the screen, and the video enhancer 17 controls the image sharpness. The 3D image frame generation unit 20 generates the 3D image frame, and the projection unit 25 divides the 3D image frame into the left-eye image sub-frame and the right-eye image sub-frame and projects the divided sub-frames on the screen.

On the other hand, the HDMI digital image signal processing block 60 as illustrated in FIG. 3 comprises an HDMI input unit 61, a scaler 15, a video enhancer 17, a 3D image frame generation unit 20, a projection unit 25, and a 3D-glasses control unit 35, and processes the 3D digital image signal input from an external device connected through an HDMI terminal.

If the digital image signal is input through the HDMI terminal and the user selects an output of a digital image signal through the HDMI terminal, the HDMI input unit 61 provides the digital image signal composed of the left-eye image frame and the right-eye image frame to the scaler 15.

The scaler 15 performs a scaling of the left-eye image frame and the right-eye image frame in accordance with the resolution of the screen, and the video enhancer 17 controls the image sharpness. The 3D image frame generation unit 20 generates the 3D image frame, and the projection unit 25 divides the 3D image frame into the left-eye image sub-frame and the right-eye image sub-frame and projects the divided sub-frames on the screen.

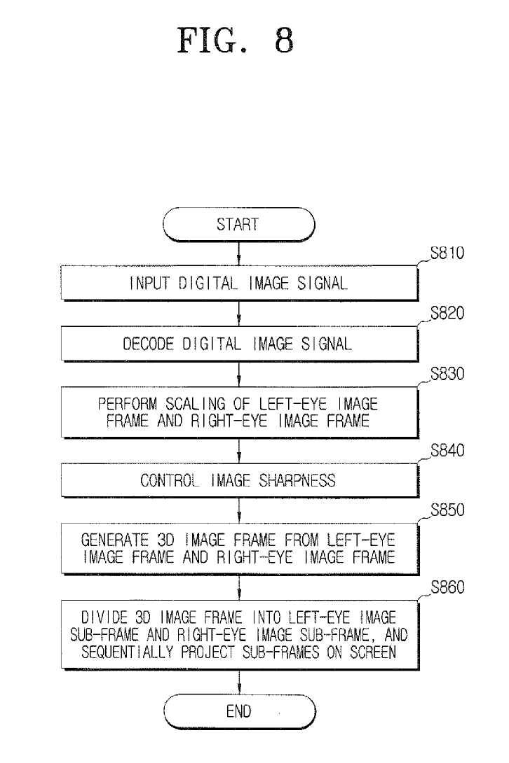

Hereinafter, a digital image signal process performed by the 3D image display apparatus as constructed above will be described with reference to FIG. 8.

If a digital image signal is input through a sky-wave (S810), the digital tuner 11 selectively receives the digital image signal of a channel selected by a user, and the decoder 13 decodes the digital image signal and provides the left-eye image frame and the right-eye image frame to the scaler 15 (S820).

The scaler 15 performs a scaling of the left-eye image frame and the right-eye image frame in accordance with the resolution of the screen (S830), and the video enhancer 17 controls the image sharpness and transfers the left-eye image frame and the right-eye image frame to the 3D image frame generation unit 20 (S840). The 3D image frame generation unit 20 receives the left-eye image frame and the right-eye image frame and generates the 3D image frame (S850). The 3D image frame is provided to the projection unit 25, and the DMD driving unit 29 controls the DMD 27 to divide the 3D image frame into the left-eye image sub-frame and the right-eye image sub-frame and to successively project the sub-frames on the screen for a time when one frame is projected (S860).

Simultaneously, the 3D-glasses control unit 35 receives the projection order of the left-eye image sub-frame and the right-eye image sub-frame from the DMD driving unit 29, and controls the turn-on/off of the left-eye glasses and the right-eye glasses accordingly.

In the exemplary embodiment of the present invention, it is exemplified that the left-eye image frame and the right-eye image frame are separately input. However, if the 3D image frame in which the left-eye image sub-frame and the right-eye image sub-frame are mixed is directly input, the decoder 13 decodes the 3D image frame, and provides the decoded image frame directly to the projection unit 25 without passing through the scaler 15 and the video enhancer 17. Then, the projection unit 25 operates the DMD 27 to divide the 3D image frame into the left-eye image signal and the right-eye image signal and to project the divided image signals on the screen.

As described above, according to the exemplary embodiments of the present invention, the 3D image signal is divided into the left-eye image frame and the right-eye image frame, and thus the scaling and the improvement of the image quality allow a clearer image to be presented.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A three-dimensional (3D) image display apparatus comprising:
an input unit which receives an input of a left-eye image frame and a right-eye image frame with a time difference between the left-eye image frame and the right-eye image frame;
a 3D image frame generation unit which generates a 3D image frame by extracting part of pixels from the left-eye image frame and extracting part of pixels from the right-eye image frame; and
a projection unit which divides the 3D image frame into a left-eye image sub-frame and a right-eye image sub-frame and successively projects the left-eye image sub-frame and the right-eye image sub-frame on a screen.

2. The 3D image display apparatus of claim 1, further comprising a scaler which controls resolutions of the left-eye image frame and the right-eye image frame.

3. The 3D image display apparatus of claim 1, wherein the 3D image frame generation unit generates the 3D image frame by alternately selecting the pixels that belong to the left-eye image frame and the pixels that belong to the right-eye image frame.

4. The 3D image display apparatus of claim 3, wherein a pair of the left-eye image sub-frame and the right-eye image sub-frame are projected on the screen for a time when one frame is projected.

5. The 3D image display apparatus of claim 3, wherein the 3D image frame generation unit generates the 3D image frame by selecting odd-numbered pixels of odd-numbered pixel lines of the left-eye image frame and even-numbered pixels of even-numbered pixel lines of the left-eye image frame, and by selecting even-numbered pixels of odd-numbered pixel lines of the right-eye image frame and odd-numbered pixels of even-numbered pixel lines of the right-eye image frame.

6. The 3D image display apparatus of claim 3, wherein the 3D image frame generation unit generates the 3D image frame by selecting odd-numbered pixels of odd-numbered pixel lines of the right-eye image frame and even-numbered pixels of even-numbered pixel lines of the right-eye image frame, and by selecting even-numbered pixels of odd-numbered pixel lines of the left-eye image frame and odd-numbered pixels of even-numbered pixel lines of the left-eye image frame.

7. The 3D image display apparatus of claim 1, wherein the 3D image frame generation unit selects the pixels from the left-eye image frame and the pixels from the right-eye image frame by judging whether the pixels are the pixels of the right-eye image frame or the pixels of the left-eye image frame through analysis of a histogram representing a level distribution of an image signal.

8. The 3D image display apparatus of claim 1, wherein the projection unit comprises:
a digital micromirror device (DMD) which reflects light onto the screen; and
a DMD driving unit which controls an operation of the DMD so that the 3D image frame is divided into the right-eye image sub-frame and the left-eye image sub-frame and the divided sub-frames are projected on the screen.

9. The 3D image display apparatus of claim 1, further comprising a 3D-glasses control unit which controls an operation of 3D glasses including left-eye glasses and right-eye glasses that are selectively turned on.

10. The 3D image display apparatus of claim 9, wherein the 3D-glasses control unit controls a turn-on order of the left-eye glasses and the right-eye glasses in accordance with a projection order of the left-eye image sub-frame and the right-eye image sub-frame.

11. The 3D image display apparatus of claim 10, wherein the 3D-glasses control unit preferentially turns on the left-eye glasses in a case where the left-eye image sub-frame is projected, and preferentially turns on the right-eye glasses in a case where the right-eye image sub-frame is projected.

12. The 3D image display apparatus of claim 1, wherein the input unit is one of a digital tuner which receives a digital image signal, an analog tuner which receives an analog image signal, and a high-definition multimedia interface (HDMI) processing unit which receives an input signal from an external device.

13. A three-dimensional (3D) image system comprising:
a 3D image display apparatus comprising an input unit which receives an input of a left-eye image frame and a right-eye image frame with a specified time difference between the left-eye image frame and the right-eye image frame;
a 3D image frame generation unit which generates a 3D image frame by extracting part of pixels from the left-eye image frame and extracting part of pixels from the right-eye image frame;
a projection unit which divides the 3D image frame into a left-eye image sub-frame and a right-eye image sub-frame and successively projects the left-eye image sub-frame and the right-eye image sub-frame on a screen; and
3D glasses which have left-eye glasses and right-eye glasses which operate in accord with a projection order of the left-eye image sub-frame and the right-eye image sub-frame.

14. A method of processing a three-dimensional (3D) image for a 3D image display apparatus, the method comprising:
receiving an input of a left-eye image frame and a right-eye image frame with a specified time difference between the left-eye image frame and the right-eye image frame;
generating a 3D image frame by extracting part of pixels from the left-eye image frame and extracting part of pixels from the right-eye image frame; and
dividing the 3D image frame into a left-eye image sub-frame and a right-eye image sub-frame and successively projecting the left-eye image sub-frame and the right-eye image sub-frame on a screen.

15. The method of claim 14, further comprising scaling the left-eye image frame and the right-eye image frame.

16. The method of claim 14, wherein generating the 3D image frame comprises generating the 3D image frame by alternately selecting the pixels that belong to the left-eye image frame and the pixels that belong to the right-eye image frame.

17. The method of claim 14, wherein in the projecting, the left-eye image sub-frame and the right-eye image sub-frame are projected on the screen for a time when one frame is projected.

18. The method of claim 16, wherein the generating the 3D image frame comprises:
selecting odd-numbered pixels of odd-numbered pixel lines of the left-eye image frame and even-numbered pixels of even-numbered pixel lines of the left-eye image frame;
selecting even-numbered pixels of odd-numbered pixel lines of the right-eye image frame and odd-numbered pixels of even-numbered pixel lines of the right-eye image frame; and
arranging the selected pixels to generate the 3D image frame.

19. The method of claim 16, wherein the generating the 3D image frame comprises:
selecting odd-numbered pixels of odd-numbered pixel lines of the right-eye image frame and even-numbered pixels of even-numbered pixel lines of the right-eye image frame;
selecting even-numbered pixels of odd-numbered pixel lines of the left-eye image frame and odd-numbered pixels of even-numbered pixel lines of the left-eye image frame; and
arranging the selected pixels to generate the 3D image frame.

20. The method of claim 14, wherein the step of generating the 3D image frame comprises selecting the pixels of the left-eye image frame and the pixels of the right-eye image frame by judging whether the pixels are the pixels of the right-eye image frame or the pixels of the left-eye image frame through analysis of a histogram representing a level distribution of the image signal.

21. The method of claim 14, further comprising controlling an operation of 3D glasses having left-eye glasses and right-eye glasses that are selectively turned on.

22. The method of claim 21, further comprising controlling a turn-on order of the left-eye glasses and the right-eye glasses of the 3D glasses in accordance with a projection order of the left-eye image sub-frame and the right-eye image sub-frame.

23. The method of claim 22, wherein the control of the turn-on order comprises preferentially turning on the left-eye glasses in a case where the left-eye image sub-frame is projected, and preferentially turning on the right-eye glasses in a case where the right-eye image sub-frame is projected.
